(19) United States
(12) Patent Application Publication
(10) Pub. No.: US 2018/0105104 A1
(43) Pub. Date: Apr. 19, 2018

(54) Vehicle temperature control system for children and pets

(71) Applicant: Vola Gean Smith, LANCASTER, TX (US)

(72) Inventor: Vola Gean Smith, LANCASTER, TX (US)

(73) Assignee: Vola Gean Smith

(21) Appl. No.: 14/994,115

(22) Filed: Jan. 12, 2016

(51) Int. Cl. B60Q 9/00; B60N 2/00; B60W 10/06; B60W 10/10; B60W 50/14; B60H 1/00

(52) U.S. Cl. CPC B60Q 9/00; B60N 2/002; B60W 10/06; B60W 10/10; B60W 50/14; B60H 1/00742; B60W 2750/40; B60H 1/00985; B60W 2050/143; B60W 2050/146; B60W 2400/00; B60W 2710/06; B60W 2710/10; B60H 1/00792

(57) ABSTRACT

A vehicle temperature control system for children and pets provides a plurality of pressure switches beneath the seats, as well as motion sensors, to detect the presence of a child or pet in a vehicle that has been shut off and parked with the doors locked. If the presence of a child or pet is detected, the system engages the climate control system, and maintains a comfortable temperature within the vehicle interior. The system provides a key fob wherein an alert light is provided, and transmits a signal to the key fob which activates the flashing alert light The system also transmits an SMS text message to the user's cellular telephone, indicating that a child or pet may have been left in the vehicle. The system also locks the transmission in park, to prevent a child from shifting the vehicle into gear after the engine has been started.

### CROSS-REFERENCE TO RELATED APPLICATIONS

Not Applicable

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to electronic systems for a vehicle and in particular to a vehicle temperature control system for children and pets. Leaving a young child or pet locked in a vehicle is unwise in most instances and illegal in many states. Unfortunately, many people still do it. They may only intend to be away from the vehicle for a minute or two, however, if something goes wrong, they could be away from the vehicle much longer. In the summer or winter, the interior temperature may become very uncomfortable and even life threatening. A vehicle temperature control system for children and pets, which detects the presence of a child or pet in a parked vehicle, starts the engine, engages the climate control system, and notifies the driver or others, would resolve this problem.

### SUMMARY OF THE INVENTION

Accordingly, the invention is directed to a vehicle temperature control system for children and pets. The system provides a plurality of pressure switches beneath the seats, as well as motion sensors, to detect the presence of a child or pet in a vehicle that has been shut off and parked with the doors locked. If the presence of a child or pet is detected, the system starts the engine, engages the climate control system, and maintains a comfortable temperature within the vehicle interior. The system provides a key fob wherein an alert light is provided, and transmits a signal to the key fob which activates the flashing alert light. The system also transmits an SMS text message to the user's cellular telephone, indicating that a child or pet may have been left in the vehicle. A similar message is also displayed on a dashboard display panel. The system also locks the transmission in park, to prevent a child from shifting the vehicle into gear after the engine has been started.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provided further understanding of the invention and are incorporated into and constitute a part of the specification. They illustrate one embodiment of the invention and, together with the description, serve to explain the principles of the invention.

FIG. 1 is a side transparency view of a vehicle with the first exemplary embodiment installed, displaying the pressure switches 10, a motion sensor 11, the dashboard display panel 12, the vehicle 16, the seats 17, and the driver's seat 17A.

FIG. 2 is a front perspective view of the center console of a passenger vehicle with the first exemplary embodiment Installed, displaying the dashboard display panel 12, and the center console 16A.

FIG. 3 is a front view of the key fob of the first exemplary embodiment, displaying the key fob 13, and the alert light 14.

FIG. 4 is a front view of a cellular telephone displaying an SMS text message transmitted by the first exemplary embodiment, displaying the SMS text message 15, the cellular telephone 18, and the visual display 19.

### DETAILED DESCRIPTION OF THE INVENTION

Referring now to the invention in more detail, the invention is directed to a vehicle temperature control system for children and pets.

The invention is intended for installation as original equipment by a vehicle manufacturer. An alternate embodiment, which may be installed as an after-market modification by the vehicle owner or by a vehicle repair or customizing shop, is contemplated.

The first exemplary embodiment is comprised of a plurality of pressure switches 10 beneath the seats 17, as well as one or more motion sensors 11, installed in the vehicle 16 to detect the presence of a child or pet in a vehicle 16 that has been shut off and parked with the doors locked. If the presence of a child or pet is detected, the system proceeds with an alert procedure which consists of starting the engine, engaging the climate control system, and maintaining a comfortable temperature within the interior of the vehicle 16. The system is preferably powered by drawing a small amount of current from the vehicle electrical system.

A combination of live conditions must be satisfied before the system will start the engine and proceed with the alert procedure. First, the pressure switch 10 beneath the driver's seat 17A must indicate pressure of less than 90 pounds, indicating that the driver has exited the vehicle. Second, the vehicle must have its doors locked with the engine off and the transmission in park. Third, a pressure switch 10 beneath a seat 17 other than the driver's seat 17A must indicate pressure greater than 5 pounds, indicating the possible presence of a child or pet. Fourth, due to the common practice of leaving heavy objects on the seats 17, such as a child safety seat or a briefcase, a motion sensor 12 must detect motion in the vehicle.

The system provides a key fob 13 wherein an alert light 14 is provided, and when the alert procedure is activated, the system transmits a signal to the key fob 13 which activates the flashing alert light 14. The key fob 13 is preferably battery powered. The system also transmits an SMS text message 15 to be displayed on the visual display 19 of the user's cellular telephone 18, indicating that a child or pet may have been left in the locked vehicle. A similar alert message is also displayed on a dashboard display panel 12, which may be installed on the dashboard or the center console 16A. The system also locks the transmission in park, to prevent a child from shifting the vehicle 17 into gear after the engine has been started.

The dashboard display panel 12 preferably provides a touchscreen function, and transitions to a display of a standard 10-key keypad after display of the alert message for a predetermined period, such as 10 seconds. The alert procedure may be deactivated by entering a three-digit code on the keypad. The keypad may be accessed at any time the engine is running by double-tapping on the touchscreen, and the system itself may be manually deactivated, preventing activation of the alert procedure, or reactivated by entering a five-digit code. Optionally, the system may also be configured to alert a vehicle security service, such as OnStar®, or other parties when the alert procedure has been activated.

Preferably, the electronic components of the dashboard display panel 32, include a transmitter which activates the alert light 14 and operates on any one of several short-range wireless communications protocols, such as Radio Frequency (RF); a transmitter which transmits an SMS text message 15 to the user's cellular telephone 18 and operates on a digital cellular telephone communications protocol; an internal ring antenna; a microprocessor; a memory device; and a touchscreen visual display. Electronic components of the key fob 13 preferably include the alert light 14; an internal ring antenna; a receiver which operates on any one of several short-range wireless communications protocols, such as Radio Frequency (RF); and one or more replaceable batteries.

To use the system, the user simply drives the vehicle. Further operation of the system is automatic.

The pressure switches 10, the motion sensors 11, the key fob 13, the alert light 14, the transmitters, the receiver, the ring antennas, the microprocessor, the memory device, and the touchscreen visual display are preferably manufactured from rigid, durable materials such as steel, aluminum alloy, brass, copper alloy, acrylic polymer, methacrylate, and plastic.

Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

1. What is claimed:

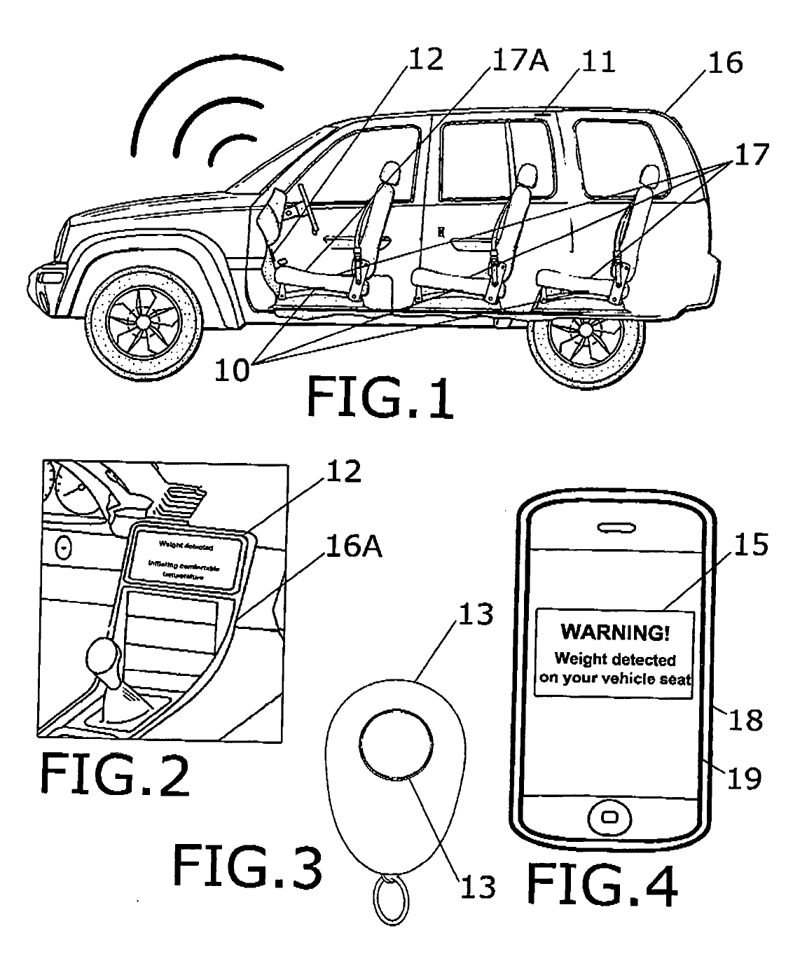

1. FIG. 1. is a side transparency view of a vehicle with the first exemplary embodiment installed, displaying the plurality of pressure switches beneath the seats 10, as well as a motion sensors 11, the dashboard display panel 12, the vehicle 16, the seats 17, and the driver's 17A. The system starts the engine, engages the climate control system, maintains a comfortable temperature. FIG. 2 a front perspective view of the center console of a passenger vehicle with the first exemplary embodiment installed, Wherein au alert light and/or audio alert. A lock transmission in park when engine has been started. FIG. 2 dashboard panel provides a weight detected and a justble temperature control touchscreen function and transition panel 12, and the center console 16A. 10-key keypad key alert message, optionally text-to-speech or desired voice alert. The ring antennas, the microprocessor the memory device the key fob 13, and the alert light 13, FIG. 3 FIG. 4 The sms text message 15, the cellular telephone call 18, and visual display weight detected on your seat 19.
